(19) United States
(12) Patent Application Publication
(10) Pub. No.: US 2007/0174178 A1
(43) Pub. Date: Jul. 26, 2007

(54) Direct access bond trading platform

(76) Inventors: Jonathan Chait, Zug (CH); Thomas Pechy Peterffy, Greenwich, CT (US); Milan Galik, Greenwich, CT (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/643,063

(22) Filed: Dec. 20, 2006

Related U.S. Application Data
(60) Provisional application No. 60/752,741, filed on Dec. 20, 2005.

(51) Int. Cl. G06Q 40/00

(52) U.S. Cl. 705/37

(57) ABSTRACT

A method for performing bond trading transactions between a trading platform and a Customer and which allows its bond customers to trade with each other and thus, providing additional liquidity. The method includes receiving, by the trading platform, bond pricing information for a particular bond from a first bond buyer/seller, receiving a bond trading transaction for the particular bond from the Customer and determining whether the bond trading transaction for the particular bond can be executed. If the bond trading transaction can be executed, the bond trading transaction for the particular bond is placed on an internal order book.

### RELATED APPLICATIONS

The present application claims priority to U.S. Provisional Patent Application Ser. No. 60/752,741, filed Dec. 20, 2005, entitled Direct Access Bond Trading Platform, the disclosure of which is incorporated herein by reference in its entirety. One related co-pending Application is U.S. patent application Ser. No. 11/104,671, filed Apr. 23, 2005, entitled System and Method for Trading Financial Instruments Using Multiple Accounts, the disclosure of which is incorporated herein by reference in its entirety.

### TECHNICAL FIELD

This disclosure relates generally to the exchange and trading of bonds or other fixed income instruments, and more particularly, to a trading platform for performing bond trading and managing bond trading exposures in other variable asset classes, such as foreign equities.

### BACKGROUND

Bonds are interest-bearing securities issued by governments, government agencies and quasi-government agencies (municipal bonds), or by commercial corporations with the promise to repay the principal at a fixed future maturity date. In general terms, bonds can trade anywhere in the world that a buyer and seller can strike a deal. There is no central place or exchange for bond trading, as there is for publicly traded stocks. The bond market is known as an “over-the-counter” market, rather than an exchange market. There are some exceptions to this. For example, some corporate bonds in the United States are listed on an exchange. Also, bond futures, and some types of bond options, are traded on exchanges. But the overwhelming majority of bonds do not trade on exchanges.

Securities brokers are licensed by the Securities and Exchange Commission to buy and sell, or trade in financial securities including commercial stocks and bonds, on behalf of members of the public, for a commission. Any licensed securities broker can trade in bonds, separate licensing is not necessary. As noted, no formally organized exchange exists for trading bonds. While investors can trade marketable bonds among themselves whenever they want, trading is usually done with securities brokers, more specifically, the bond trading desks (i.e., bond dealers) of major securities brokers. These bond dealers (hereinafter, dealers) utilize the vast network of telephone and computer links that connect the interested players. Dealers usually “make a market” for bonds. What this means is that the responsibility of the dealer is to know all about a group of bonds and to be prepared to quote a price; i.e., bid/ask. Bid is the price the dealer will pay for a bond and ask is the price at which the dealer will sell a bond. Spread is the difference between the price the dealer will buy a bond at (bid), and the price the dealer will sell a bond (ask).

The role of the dealers is to provide “liquidity” for bond investors, thereby allowing bond investors to buy and sell bonds more easily and with a limited concession on the price. Dealers also buy and sell amongst themselves, either directly or anonymously via bond brokers who deal only with dealers and not the general public. Bond brokers act on behalf of dealers and maintain “books” of the highest bid a prospective purchasing dealer is willing to make and of the lowest ask by a prospective selling dealer on numerous different bond issues. When dealers buy and sell amongst themselves, they make (or lose) money based upon the spread.

In a typical bond trading environment, the dealer offers its Customers (bond investors) bid/ask prices that may include some markup to generate revenue or profit for the dealer. For example, a seller of a bond delivers a quote of “ask” at 15 while the bond dealer will displays to its Customers a 15.5 price; see FIG. 1. Furthermore, the dealer is executing the bond trade as a counterparty in terms of the credit risk. One disadvantage of this technique is that Customers may not be given the best available prices. Customers cannot easily evaluate whether the dealer is offering the best available price in the market because the dealer is marking up the prices that it receives from a Customer requesting to buy a bond (buy Customer) and a Customer requesting to sell a bond (sell Customer). Also, in the execution of the trades, the dealer may be taking an adversarial position vis-à-vis the buy/sell Customer while also charging the Customer a set commission at the same time.

Additionally, dealers offer only a quote-style or quote-driven marketplace. For example, if the dealer is offering a particular bond 10 bid at 15 ask, and if a sell Customer in response offers to sell at 12 for the bid at 10, the dealer will reject the offer because it is dealing at 10 bid and 15 ask only. Even if other buy/sell Customers may accept orders between the posted quotes (i.e., between 10 bid and 15 ask), the dealers nonetheless hide these transactions from sell/buy Customers. Continuing with the previous example, if a sell Customer places an order for a particular bond to sell at 12, i.e., a non-marketable order, a dealer may accept the order and only execute it when the dealer's prices match the order (e.g., 12 bid at 17 ask). Assuming the fair value is the midpoint of the bid/ask spread, in this example the dealer would treat a 12 bid at a point in time when the fair value is actually 14.5 (i.e., the midpoint between 12 bid and 17 ask); see FIG. 2. Thus, the dealer would not allow non-marketable quote execution. Again, in contrast, this bond trading platform would allow a buy/sell Customer executing trade between the dealer quotes (10 bid and 15 ask) if another sell/buy Customer would be willing to enter into a trade, e.g., at 12½ bid and ask. Thus, a sell Customer with the bid at 12½ would sell at a higher price than at the dealer bid (to buy) of 10, and a buy Customer with the ask 12 would buy at a lower price than at the dealer ask (to sell) quote of 15.

Thus, realizing these inefficiencies, what is needed is a bond trading platform that provides an exchange-style (as opposed to order-driven) order book that includes composite information about the best available price in the market. What is further needed is a bond trading platform that provides a broad set of tools for managing complex bond trades and for managing the exposure in post-trade assets as multicurrency cash balances. What is also need is a bond trading platform that acts as a pure agent by passing on the true quoted prices from bond buyers/sellers without any markups.

### SUMMARY

This and other advantages are met by the present invention. According to one aspect, the present invention includes a method for performing a bond trading transaction between a trading platform and a Customer. The method includes receiving, by the trading platform, bond pricing information for a particular bond from a first bond buyer/seller, receiving a bond trading transaction for the particular bond from the Customer and determining whether the bond trading transaction for the particular bond can be executed. If the bond trading transaction can be executed, the bond trading transaction for the particular bond is placed on an internal order book.

The method further includes receiving, by the trading platform, bond pricing information for the particular bond from a second bond buyer/seller and generating a composite bond price for the particular bond based on the pricing information received from the first and the second bond buyers/sellers. Generating a composite bond price includes evaluating the bond pricing information for the particular bond received from the first and second bond buyers/sellers to identify a best seller and a best buyer for the particular bond, and routing the bond trading transaction for the particular bond to at least one of the best seller and the best buyer. The bond pricing information includes a plurality of different bonds.

Another aspect of the invention provides a computer product comprising a computer usable medium, having encoded thereon a computer readable program for enabling performing a bond trading transaction between a trading platform and a Customer by performing the operations of receiving, by the trading platform, bond pricing information for a particular bond from a first bond buyer/seller, receiving a bond trading transaction for the particular bond from the Customer, determining whether the bond trading transaction for the particular bond can be executed and, in response to the determining, placing the bond trading transaction for the particular bond on an internal order book.

Additional advantages of the present invention will become readily apparent to those skilled in the art from the following detailed description, wherein only an exemplary embodiment of the present invention is shown and described, simply by way of illustration of the best mode contemplated for carrying out the present invention. As will be realized, the present invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The accompanying drawings illustrate several embodiments and, together with the description, serve to explain the principles of the disclosure.

FIG. 1 is a diagram illustrating two different models of a bond trading platform (the riskless principle model and the agency model) according to an embodiment of the present disclosure.

FIG. 2 is a diagram illustrating execution of non-marketable quotes via internalizing order flow on the books of the trading platform according to an embodiment of the present disclosure.

FIG. 3 is a diagram further illustrating quote consolidation and general bond trading principles according to an embodiment of the present disclosure.

FIG. 4 is a diagram illustrating consolidating of the various dealers quotes via smart routing processes and a data link according to an embodiment of the present disclosure.

FIG. 5 is a diagram illustrating execution of customer orders acting on dealer quotes via a trade link with dealers according to an embodiment of the present disclosure.

FIG. 6 is a diagram illustrating trade execution after best quotes were obtained.

FIG. 7 illustrates overall operation of trading platforms according to an embodiment of the present disclosure.

FIG. 8 is a diagram illustrating a computing device.

### CONCISE DESCRIPTION OF THE EMBODIMENTS

The following numbered statements set forth a concise description of the concepts presented herein:

### DETAILED DESCRIPTION OF THE EMBODIMENTS

The present disclosure is now described more fully with reference to the accompanying figures. The present disclosure may be embodied in many different forms and should not be construed as limited to embodiments set forth herein. Rather these embodiments are provided so that this disclosure will be thorough and complete and will fully convey the concepts to those skilled in the art.

A. System Overview

In certain embodiments of the present disclosure, a computer-implemented bond trading platform is provided. The bond trading platform receives a data stream from one or more bond dealers. Each of the data streams includes a real-time representation of the bid/ask prices and for a particular bond dealer. The trading platform aggregates or consolidates the information to present the best available prices (a composite price or consolidated price) to its customers. Customer orders can be routed to the bond dealers for execution or executed within the trading platform itself. This enables customers to perform bond trades with other customers for orders that are non-marketable.

The non-marketable customer orders are managed on an internal order book. The bid/ask prices on the internal order book are also included in the composite price information available to customers. By transparently offering its customers the same prices provided by the bond dealers (and/or from the internal order book), the trading platform advantageously functions as a pure agent in the transaction. In this configuration, the trading platform charges a predefined commission for the transaction, rather than modifying the price quotes received from the dealers or generating revenue on bid/ask spreads. Another advantage of this arrangement is that the trading platform avoids taking an adversarial position vis-à-vis the bond dealers or the customers.

Another aspect of the trading platform is the management of asset exposures. A multicurrency account management system and interface enable customers to perform multicurrency bond trades without opening multiple bank accounts around the world. From the customer's perspective, performing bond trading is seamless because a customer can deposit a single currency in an account and trade a bond denominated in another currency. Certain aspects of account management, such as margining, which may be implemented in conjunction with embodiments of the present disclosure are described in additional detail in the U.S. Patent Application of Thomas P. Peterffy et al., Ser. No. 10/465,827, filed Jun. 20, 2003, entitled “System for Managing Multiple Types of Accounts having Different Regulatory Requirements,” and U.S. Provisional Application of Jonathan Chaitt, Ser. No. 60/689,064, filed Jun. 10, 2005, entitled “Foreign Exchange Trading Platform”, the pertinent disclosures of which are incorporated by reference herein.

B. Trading Platform

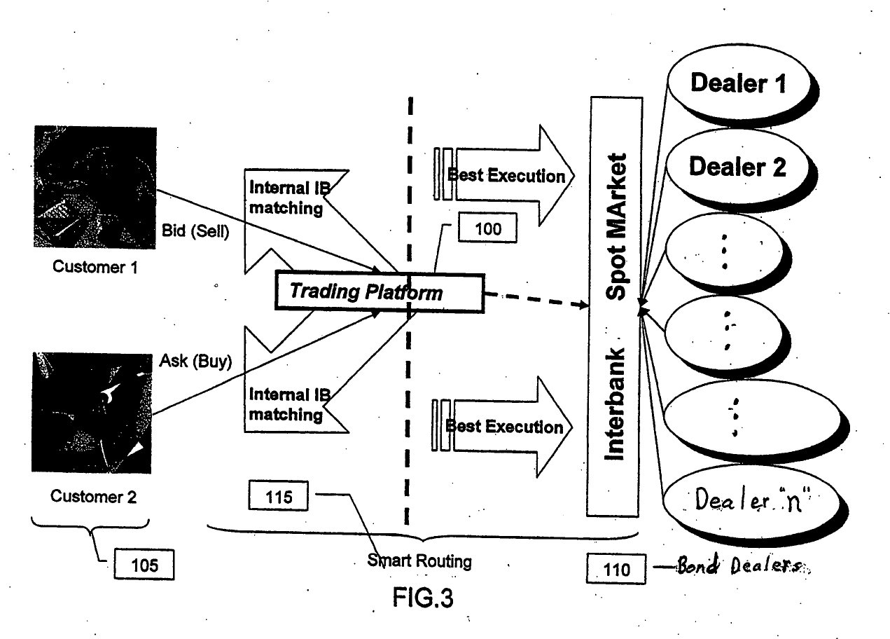

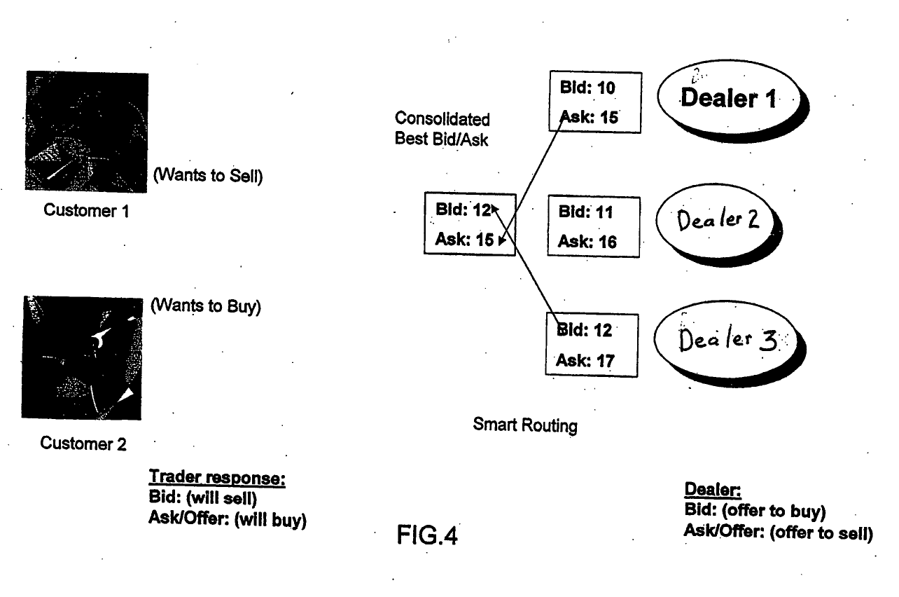

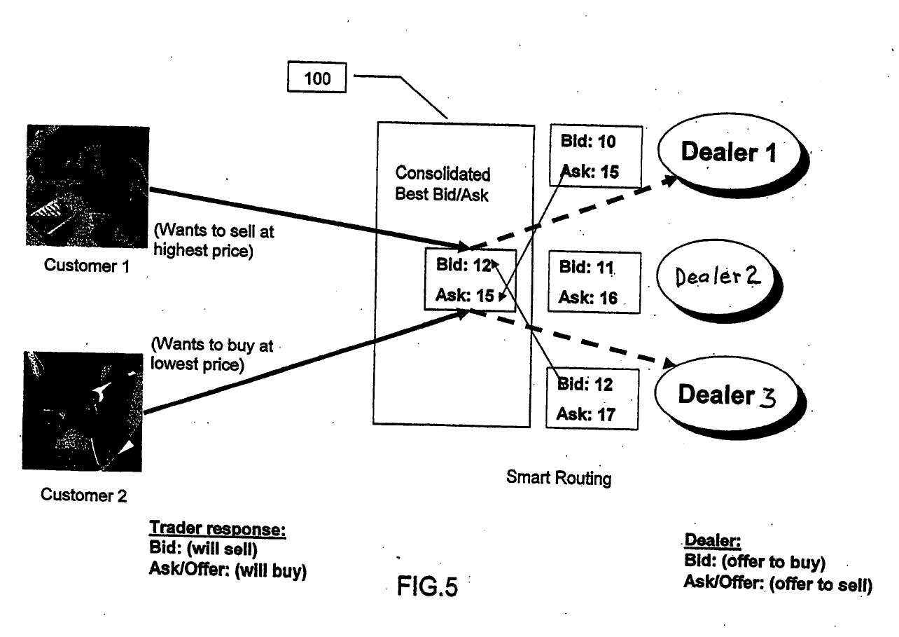

FIG. 3 is a diagram illustrating a bond trading platform according to an embodiment of the present disclosure. The illustrated embodiment includes a trading platform 100, a plurality of Customers 105, and a plurality of bond dealers 110. The trading platform 100 establishes connectivity to the plurality of bond dealers 110 using conventional data exchange techniques. In the illustrated embodiment, the bond dealers 110 are third-party bond dealers. The bond dealers provide a data channel for submitting quotes (the data channel) and submitting orders and receiving trade confirmations (i.e., a trading channel). The data channel includes current real-time quotes for the various bonds. The trading platform 100 receives the real-time quotes and consolidates them into a best of market view that is advantageously presented to the Customer 105 in an exchange-style order book. Further details of the data consolidation are provided below with reference to FIGS. 4-5.

The trading platform 100 also incorporates smart routing logic 115. Smart routing refers to the ability of the trading platform 100 to obtain best execution for the Customer by electronically routing the orders to one or more of the bond dealers 110. Component parts of the orders may be split among one or more of the bond dealers 110 and/or executed from the internally managed order book to achieve the best possible execution.

1. Quote Consolidation and Smart Routing

FIGS. 4-5 are diagrams illustrating quote consolidation and smart routing according to an embodiment of the present disclosure. To further describe how quotes from the plurality of bond dealers 110 are consolidated, FIG. 5 includes an example having three bond dealers. Each of the bond dealers provides a real-time quote to the trading platform 100 for a particular bond. As one skilled in the art will appreciate, the illustrated example includes hypothetical numbers to demonstrate the concepts of the disclosure. Customer 1 wants to sell a particular bond. Customer 2 wants to buy the particular bond. Dealer 1 provides a bid of 10 and an ask of 15. Dealer 2 provides a bid of 11 and an ask of 16. Dealer 3 provides a bid of 12 and an ask of 17. The trading platform 100 evaluates each of these quotes and provides a consolidated or composite quote of bid at 12 (which is the highest available price to sell the bond) and ask at 15 (which is the lowest available price to buy the bond). In one implementation, the consolidated quote is visually presented for the Customer in an exchange-style order book. The consolidated quote represents the best available prices from the set provided by the bond dealers, and, unlike other trading platforms is a composite quote from the multiple bond dealers.

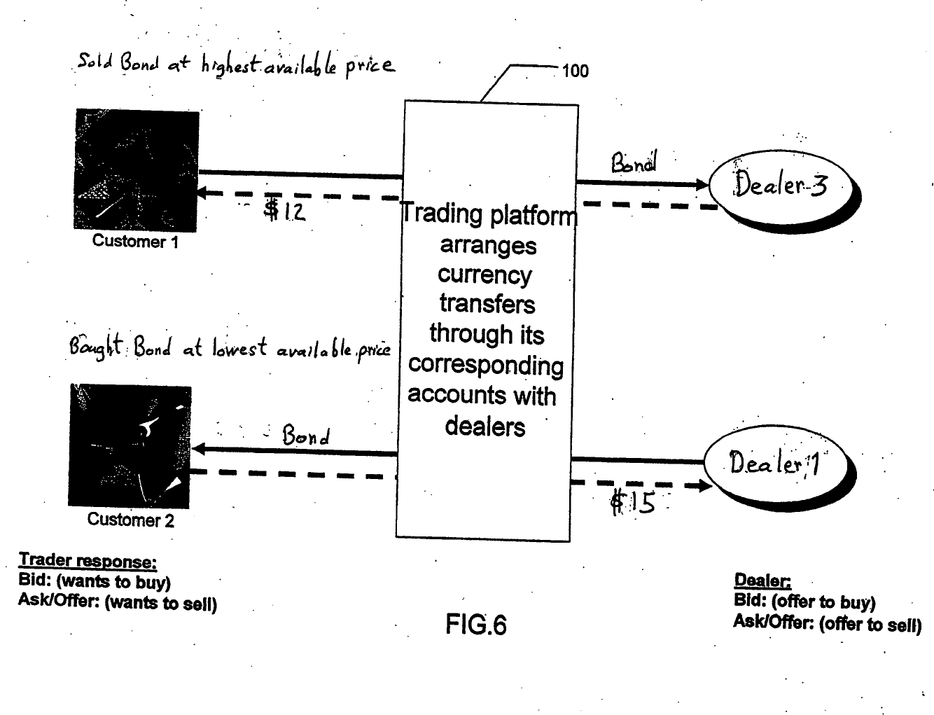

FIG. 6 illustrates an example of the smart routing technique and trade execution. As will be appreciated by persons skilled in the art, the plurality of bond dealers are abstracted from the Customer's point of view. The Customer receives best of market prices, and the trading platform determines how to route the order for execution. If Customer 2 places an order to buy at 15, then his order is executed with dealer 1 who has an ask price of 15. If Customer 1 places an order to sell at 12, then his order is executed with dealer 3 who has an a bid price of 12.

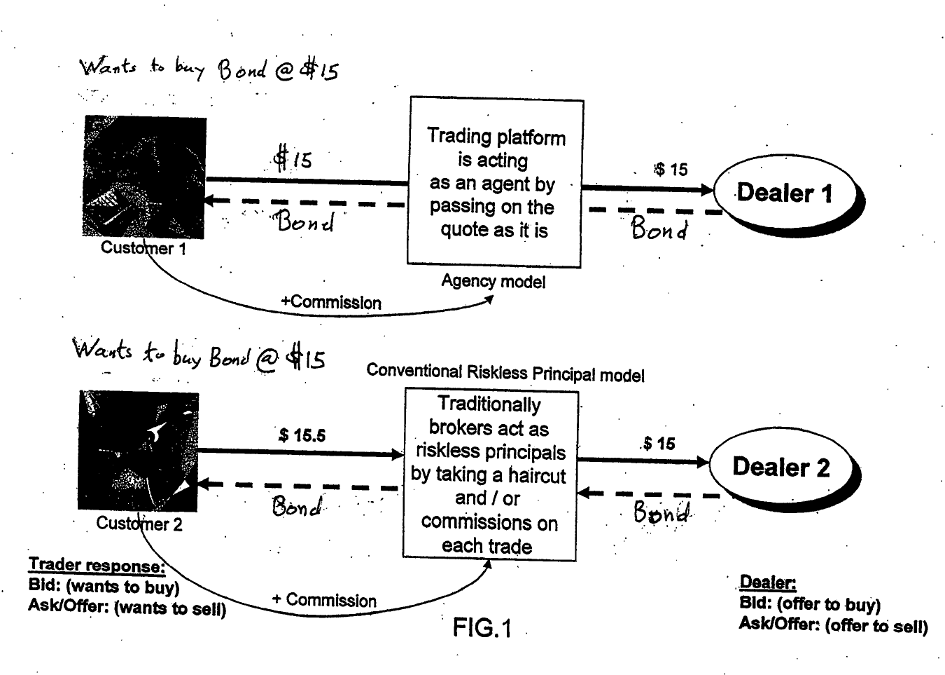

The embodiment illustrated in FIG. 6 shows the banking actions associated with executing a bond trade. The trading platform 100 arranges the bond transfers on behalf of its Customers. Further details on the relationship of the Customer with the trading platform 100 are described below and also shown in FIG. 1.

2. Non-Marketable Orders

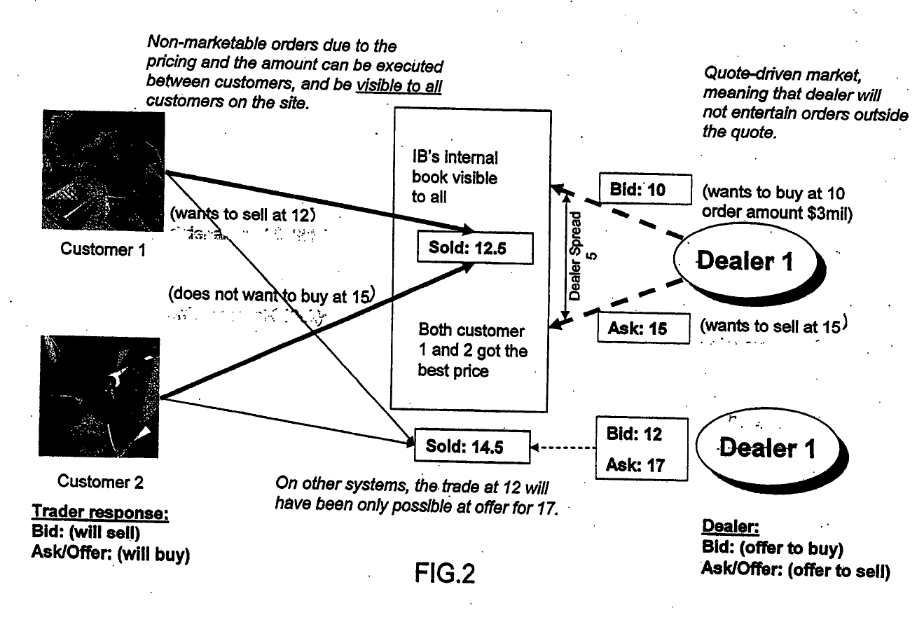

Non-marketable customer orders are managed on an internal order book. The bid/ask prices on the internal order book are also included in the composite price information available to Customers. FIG. 2 illustrates an example of a customer-to-customer bond trade. Dealer 1 (who is quote driven) has bid at 10 and ask at 15 (with a spread of 5). Customer 1 wants to sell at 12, which is greater than dealer 1's bid price. The trading platform internally books this order because it cannot be executed with dealer 1. Customer 2, however, does not want to buy at 15, which is dealer 1's ask price. Because the bond orders that are internally booked are also included in the composite price information, Customer 2 has visibility of the better deal from Customer 1 (in certain implementations, the Customer quote is evident to other customers because it will be for an amount that would be lower than normally offered by a dealer). The trading platform matches the transactions, and both Customers 1 and 2 get the best price at 12.5 (which is a mid-point between Buyer/Seller/s quotes).

3. Agency Role

By transparently offering its customers the same prices provided by the liquidity providers (and/or from the internal order book), the trading platform advantageously functions as a pure agent in the transaction even though it legally functions as a riskless principal by being the only single credit counterparty to both the dealers and the customers. FIG. 1 contrasts the agency approach with the conventional riskless principal model. According to the concepts of the present disclosure, the trading platform charges a predefined commission for the transaction, rather than modifying the price quotes received from the bond dealers or generating revenue on bid/ask spreads. Another advantage of this arrangement is that the trading platform avoids taking an adversarial position vis-à-vis the bond dealers or the customers.

4. Transaction Process

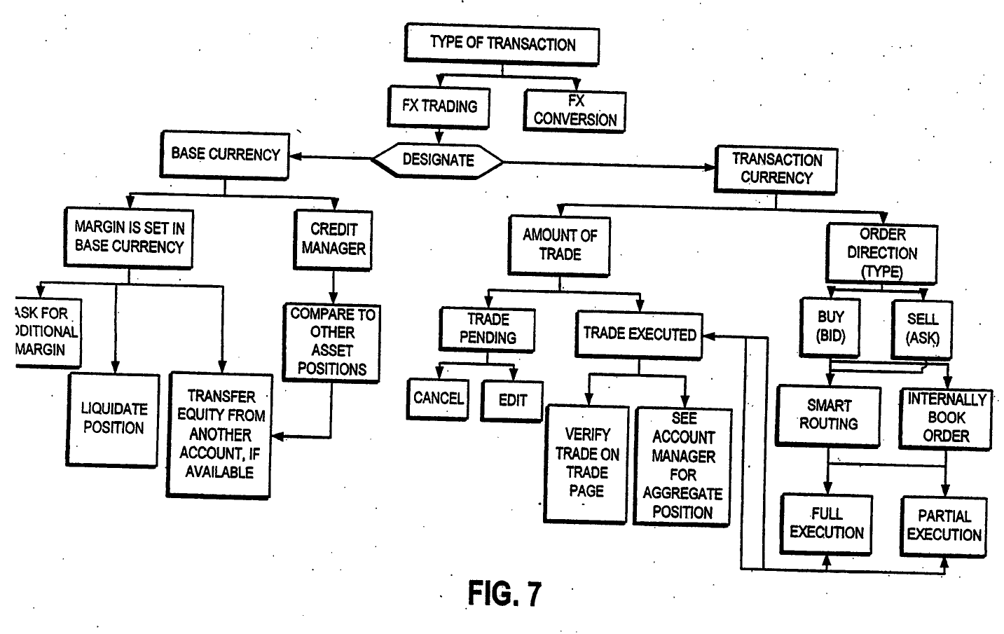

FIG. 7 illustrates the steps that are taken when a typical bond trade transaction is executed in one implementation of the disclosed concepts. First, a Customer decides whether he or she will utilize the bond trading or the currency conversion facility on the trading platform. If the Customer chose the trading facility, the Customer will need to designate the base currency, i.e., the currency in which the Customer's universal wealth will be determined and against which all other assets will be benchmarked. For example, if the base currency is selected in US dollars, this means that all trades and all assets purchased or sold on the trading platform will be measured in their present value vis-à-vis US dollars. In other words, the base currency is an invariant asset class, and all other assets are variant and may fluctuate in value depending on the direction of the market, as with for example stocks or bonds, or the direction of the currency exchange rates, as would be the case with currency trading. After making an initial deposit of liquidity in the designated base currency, the Customer can start trading. There are two inherent risks with trading non-US assets: assets risk (e.g., movement in bond prices) and currency exposure (e.g., movement US$/ [symbol] rate) These are variant asset categories and margin is calculated with respect to variant asset categories.

Returning now to FIG. 7, after transaction (or underlying) currency has been designated, Customer specifies the amount of the proposed bond trade and the type of the order, such as a buy order or a sell order. As explained above, the trading screen where the orders are placed provides the aggregate best quote generated via smart routing mechanism on the trading platform. In certain embodiments, these aggregate bid and ask quotes are continuously updated and the Customer will have a real-time view of the market and where his or her quote is as compared to the market. Until the posted Customer's quote is accepted and transmitted, the quote can be cancelled and or modified. After the order has been executed, the order cannot be modified and instead will be displayed on the order log screen. The order may be executed partially or fully.

In addition to specifying whether it is a buy or a sell order, the Customer will also designate what kind of an order this would be. The trading platform offers a wide slate of various kinds of orders, such as market order, limit order, and other various kinds of combination orders.

C. Computing Device

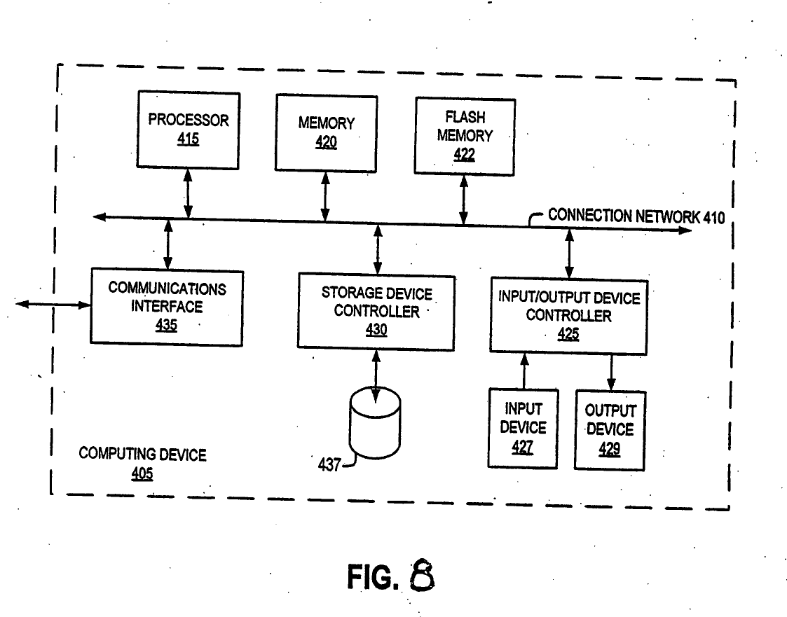

FIG. 8 is a diagram illustrating a computing device. A computing device is generally an efficient way of implementing the features or functions disclosed herein. In the examples described above, a computing device is used to implement the features of the trading platform 100, such as electronic order submission and execution.

In the illustrated embodiment, the computing device 405 includes a connection network 410, a processor 415, a memory 420, a flash memory 422, an input/output device controller 425, an input device 427, an output device 429, a storage device controller 430, and a communications interface 435. Also included is an internal storage device 437.

The connection network 410 operatively couples each of the processor 415, the memory 420, the flash memory 422, the input/output device controller 425, the storage device controller 430, and the communications interface 435. The connection network 410 can be an electrical bus, switch fabric, or other suitable interconnection system.

The processor 415 is a conventional microprocessor. The processor 415 executes instructions or program code modules from the memory 420 or the flash memory 422. The operation of the computing device 405 is programmable and configured by the program code modules. Such instructions may be read into memory 420 or the flash memory 422 from a computer readable medium, such as a device coupled to the storage device controller 430.

Execution of the sequences of instructions contained in the memory 420 or the flash memory 422 cause the processor 415 to perform the method or functions described herein. Although a single computing device is shown, one skilled in the art will appreciate that the functionality described herein may be implemented using a component software architecture (e.g., Java 2 Enterprise Edition) and distributed among a plurality of computing devices. In alternative embodiments, hardwired circuitry may be used in place of or in combination with software instructions to implement aspects of the disclosure. Thus, embodiments of the disclosure are not limited to any specific combination of hardware circuitry and software. The memory 420 can be, for example, one or more conventional random access memory (RAM) devices. The flash memory 422 can be one or more conventional flash RAM, or electronically erasable programmable read only memory (EEPROM) devices. The memory 420 may also be used for storing temporary variables or other intermediate information during execution of instructions by processor 415.

The input/output device controller 425 provides an interface to the input device 427 and the output device 429. The output device 429 can be, for example, a conventional display screen. The display screen can include associated hardware, software, or other devices that are needed to generate a screen display. The illustrated embodiment also includes an input device 427 operatively coupled to the input/output device controller 425. The input device 427 can be, for example, an external or integrated keyboard or cursor control pad.

The storage device controller 430 can be used to interface the processor 415 to various memory or storage devices. In the illustrated embodiment, the internal storage device 437 is shown for storing software applications (e.g., an account management interface), user data, system configuration, and the like. As one skilled in the art will appreciate, the internal storage device 437 can be any suitable storage medium, such as magnetic, optical, or electrical storage.

The communications interface 435 provides bidirectional data communication coupling for the computing device 405. The communications interface 435 can be functionally coupled to a local area or wide area network. In one embodiment, the communications interface 435 provides one or more input/output ports for receiving electrical, radio frequency, or optical signals and converts signals received on the port(s) to a format suitable for transmission on the connection network 410. The communications interface 435 can include a radio frequency modem and other logic associated with sending and receiving wireless or wireline communications. For example, the communications interface 435 can provide an Ethernet interface, Bluetooth, and/or 802.11 wireless capability for the computing device 405.

Having described embodiments of the bond trading platform (which are intended to be illustrative and not limiting), it is noted that modifications and variations can be made by persons skilled in the art in light of the above teachings. It is therefore to be understood that changes may be made in the particular embodiments or implementations disclosed.

Trading bonds is the latest addition to the direct-access platform that has been described in previously filed patent applications that relate to trading in equities, ETFs, options, futures and foreign exchange that can be performed in multiple markets in different countries from a single account. Entering bond orders is now as simple and easy as placing orders for equities, derivatives and currencies. Also, the smart routing order routing system will be able to dynamically seek the best price available among at least three debt-trading venues, for example, delivering immediate execution on the NYSE or Timber Hill, if they display the best available price. Or, alternatively, if the BondDesk is at the best price, then the smart routing system will send the order to that destination.

Thus, using one universal account, a customer can place a bond order and have it routed to three different types of venues—a listed market (e.g., NYSE), a bond market consolidator (e.g., BondDesk), or a single dealer platform (e.g., Deutsche Bank). The routing system maintains, or can find, the information to identify and/or locate the best market for the bond order. Additionally, multi-currency transactions are also possible.

1. A method for performing a bond trading transaction between a trading platform and a customer, the method comprising:
receiving, by the trading platform, bond pricing information for a particular bond from a first liquidity provider;
receiving the bond trading transaction for the particular bond from the customer;
determining whether the bond trading transaction can be executed; and
responsive to the determining, placing the bond trading transaction on an internal order book.

2. The method of claim 1, further comprising:
receiving, by the trading platform, bond pricing information for the particular bond from a second liquidity provider; and
generating a composite price for the particular bond based on the bond pricing information received from the first and the second liquidity providers.

3. The method of claim 2, wherein generating a composite price for the particular bond further comprises:
evaluating the bond pricing information received from the first and second liquidity providers to identify a best seller and a best buyer from a perspective of the customer; and
routing the bond trading transaction to at least one of the best seller and the best buyer.

4. The method of claim 3, further comprising:
repeating the receiving of bond pricing information for a plurality of liquidity providers; and
repeating the generating of a composite price for the particular bond based on the pricing information received from the plurality of liquidity providers.

5. The method of claim 1, wherein the bond pricing information includes a plurality of different bonds.

6. The method of claim 1, wherein the bond pricing information includes a bid price and the step of determining is performed using the bid price.

7. The method of claim 6, wherein the trading platform charges the customer a commission based on an amount of the bond trading transaction.

8. The method of claim 1, wherein the bond pricing information includes an ask price and the step of determining is performed using the ask price.

9. The method of claim 8, wherein the trading platform charges the customer a commission based on an amount of the bond trading transaction.

10. The method of claim 1, further comprising the step of:
receiving, by the trading platform, at least one of a bid price and ask price from another customer related to the particular bond;
generating a composite price for the particular bond based on the pricing information received from the first liquidity provider and the at least one bid price and ask price from the another customer.

11. The method of claim 1, further comprising the steps of:
receiving from the customer a transaction request for an asset other than a bond trading transaction; and
performing the transaction request.

12. The method of claim 11, wherein the transaction request relates to buying or selling one or more equity instruments.

13. The method of claim 12, further comprising the step of:
managing an account for the customer such that the one or more equity instruments are valued according to a base currency selected by the customer.

14. The method of claim 13, wherein all assets within the account are valued according to the base currency.

15. The method of claim 14, wherein the base currency is changeable by the customer without liquidating any assets within the account.

16. A system for performing a bond trading transaction for a customer, the system comprising:
a trading platform configured to receive bond pricing information for a particular bond from a first liquidity provider and to receive the bond trading transaction from the customer;
a quote matching component configured to determine whether the bond trading transaction can be executed; and
an internal order book, responsive to the quote matching system, in which the bond trading transaction is placed.

17. The system of claim 16, wherein the trading platform is further configured to receive bon pricing information for the particular bond from a second liquidity provider; and the system further comprising:
a composite price generator configured to generate a composite price for the particular bond based on the pricing information received from the first and the second liquidity providers.

18. The system of claim 17, wherein the composite price generator is further configured to:
evaluate the bond pricing information received from the first and second liquidity providers to identify a best seller and a best buyer from a perspective of the customer; and
route the bond trading transaction to at least one of the best seller and the best buyer.

19. The system of claim 18, wherein:
the receiver is further configured to repeat receiving of bond pricing information for the particular bond from a plurality of liquidity providers; and
the composite price generator is further configured to generate a composite price for the particular bond based on the pricing information received from the plurality of liquidity providers.

20. The system of claim 16, wherein the bond pricing information includes a plurality of different bonds.

21. The system of claim 16, wherein the bond pricing information includes a bid price and the quote matching component is configured to use the bid price in determining whether the bond trading transaction can be executed.

22. The system of claim 21, wherein the trading platform charges the customer a commission based on an amount of the bond trading transaction.

23. The system of claim 16, wherein the currency pair pricing information includes an ask price and the quote matching component is configured to use the bid price in determining whether the bond trading transaction can be executed.

24. The system of claim 23, wherein the trading platform charges the customer a commission based on an amount of the bond trading transaction.

25. The system of claim 16, wherein the receiver is further configured to receive at least one of a bid price and ask price from another customer related to the particular bond; and the system further comprises:
a composite price generator configured to generate a composite price for the particular bond based on the pricing information received from the first liquidity provider and the at least one bid price and ask price from the another customer.

26. The system of claim 16, wherein the receiver is further configured to receive from the customer a transaction request for an asset other than a bond trading transaction; and the system further comprises:
a non-bond trading platform configured to perform the transaction request.

27. The system of claim 26, wherein the transaction request relates to buying or selling one or more equity instruments.

28. The system of claim 27, further comprising an account manager configured to:
manage an account for the customer such that the one or more equity instruments are valued according to a base currency selected by the customer.

29. The system of claim 28, wherein all assets within the account are valued according to the base currency.

30. The system of claim 28, wherein the base currency is changeable by the customer without liquidating any assets within the account.

31. A computer readable medium bearing executable instructions for performing a bond trading transaction between a trading platform and a customer, the instructions upon execution cause one or more processors to perform the steps of:
receiving, by the trading platform, bond pricing information for a particular bond from a first liquidity provider;
receiving the bond trading transaction for the particular bond from the customer;
determining whether the bond trading transaction can be executed; and
responsive to the determining, placing the bond trading transaction on an internal order book.
